(19) United States
(12) Patent Application Publication
(10) Pub. No.: US 2020/0392290 A1
(43) Pub. Date: Dec. 17, 2020

(54) POLY(AMIDE-IMIDE) COPOLYMER, COMPOSITION FOR THIN FILM AND THIN FILM

(71) Applicant: Daxin Materials Corporation, Taichung City (TW)

(72) Inventors: Guan-Ping Chen, Taichung City (TW); Dian-Cing Lin, Taichung City (TW); Min-Tzu Kao, Taichung City (TW)

(73) Assignee: Daxin Materials Corporation, Taichung City (TW)

(21) Appl. No.: 16/726,268

(22) Filed: Dec. 24, 2019

(30) Foreign Application Priority Data
Jun. 14, 2019 (TW) 108120642

(51) Int. Cl. C08G 73/14; C08J 5/18

(52) U.S. Cl. CPC C08G 73/14; C08J 2379/08; C08J 5/18

(57) ABSTRACT

A poly(amide-imide) copolymer, a composition for a thin film, and a thin film are provided. The poly(amide-imide) copolymer is synthesized by polymerization, dehydration cyclization, and hydrolysis condensation of an aromatic diamine monomer, a diacyl chloride monomer, a tetracarboxylic dianhydride monomer, and a silane compound having an alkoxy group as an end-capping agent. The aromatic diamine monomer includes 2,2′-bis(trifluoromethyl)benzidine. Based on a usage amount of 100 mol % of the aromatic diamine monomer, a usage amount of the 2,2′-bis(trifluoromethyl)benzidine is 70 mol % or more.

### CROSS-REFERENCE TO RELATED APPLICATION

This application claims the priority benefit of Taiwan application serial no. 108120642, filed on Jun. 14, 2019. The entirety of the above-mentioned patent application is hereby incorporated by reference herein and made a part of this specification.

### BACKGROUND OF THE INVENTION

### Field of the Invention

The invention relates to a copolymer, a composition for a thin film, and a thin film, and more particularly to a poly(amide-imide) copolymer, a composition for a thin film, and a thin film.

### Description of Related Art

Polyimide (PI) has excellent heat resistance, mechanical properties, and electrical properties, and thus is widely used as a molding material, an electronic material, an optical material, and the like, and is widely used in various fields. However, a thin film formed of polyimide has the issue of insufficient hardness. For example, a thin film formed of polyimide usually has a pencil hardness less than 3B, which may cause damage to the surface of the thin film such as scratching or breakage, thereby affecting the performance of the device using the thin film. Further, in recent years, although poly(amide-imide) copolymers have been developed to form a thin film, the thin film formed of these poly(amide-imide) copolymers still has the issue of poor optical properties.

### SUMMARY OF THE INVENTION

The invention provides a poly(amide-imide) copolymer which may form a thin film having good light transmittance (optical properties), yellowing resistance, and hardness.

A poly(amide-imide) copolymer of the invention is synthesized by polymerization, dehydration cyclization, and hydrolysis condensation of an aromatic diamine monomer, a diacyl chloride monomer, a tetracarboxylic dianhydride monomer, and a silane compound having an alkoxy group. The silane compound having the alkoxy group is used as an end-capping agent. The aromatic diamine monomer includes a 2,2′-bis(trifluoromethyl)benzidine (TFMB). Based on a usage amount of 100 mol % of the aromatic diamine monomer, a usage amount of the 2,2′-bis(trifluoromethyl)benzidine is 70 mol % or more.

In an embodiment of the invention, the poly(amide-imide) copolymer includes an amide structural unit and an imide structural unit. The amide structural unit is formed by reacting the aromatic diamine monomer and the diacyl chloride monomer. The imide structural unit is formed by reacting the aromatic diamine monomer and the tetracarboxylic dianhydride monomer.

In an embodiment of the invention, the aromatic diamine monomer further includes at least one of 2,2′-bis(3-amino-4-hydroxyphenyl)hexafluoropropane (bis APAF), 4,4′-diaminodiphenylsulfone (4,4′-DDS), and 3,3′-diaminodiphenylsulfone (3,3′-DDS).

In an embodiment of the invention, a weight-average molecular weight of the poly(amide-imide) copolymer is between 150,000 and 500,000.

In an embodiment of the invention, the tetracarboxylic dianhydride monomer includes at least one of 4,4′-(hexafluoroisopropylidene)diphthalic anhydride (6FDA), 3,3′,4,4′-biphenyltetracarboxylic dianhydride (BPDA), and 1,2,3,4-cyclobutanetetracarboxylic dianhydride (CBDA).

In an embodiment of the invention, the silane compound having the alkoxy group includes at least one of a silane compound having an alkoxy group and an amine group and a silane compound having an alkoxy group and an isocyanate group.

In an embodiment of the invention, the silane compound having the alkoxy group and the amine group includes at least one of (3-aminopropyl)triethoxysilane (APTES) and (3-aminopropyl)trimethoxysilane (APTMS).

In an embodiment of the invention, the silane compound having the alkoxy group and the isocyanate group includes 3-isocyanatopropyltriethoxysilane.

In an embodiment of the invention, the diacyl chloride monomer includes at least one of terephthaloyl chloride (TPC), isophthaloyl dichloride (IPC), 4,4′-diphenoyl chloride, and 2,2′-diphenoyl chloride.

In an embodiment of the invention, based on a total usage amount of 100 parts by mole of the diacyl chloride monomer and the tetracarboxylic dianhydride monomer, a usage amount of the aromatic diamine monomer is between 70 parts by mole and 100 parts by mole, a usage amount of the diacyl chloride monomer is between 30 parts by mole and 70 parts by mole, a usage amount of the tetracarboxylic dianhydride monomer is between 30 parts by mole and 70 parts by mole, and a usage amount of the silane compound having the alkoxy group is between 5 parts by mole and 20 parts by mole.

A poly(amide-imide) copolymer of the invention includes a structural unit represented by formula (1), a structural unit represented by formula (2), a structural unit represented by formula (3), and a silicon-oxygen-silicon bond.

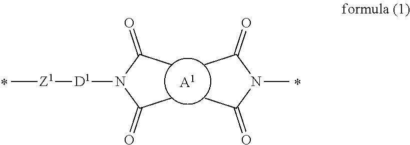

In formula (1), A¹ is a tetravalent organic group, D¹ is a divalent organic group, Z¹ is a single bond or —NH—, and * represents a bonding position.

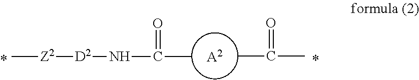

In formula (2), A² is a divalent organic group, D² is a divalent organic group, Z² is a single bond or —NH—, and * represents a bonding position.

In formula (1) and formula (2), at least one of D¹ and D² is a structure represented by formula (D-1), wherein based on a total amount of 100 mol % of D¹ and D² in the poly(amide-imide) copolymer, an amount of the structure represented by formula (D-1) is 70 mol % or more.

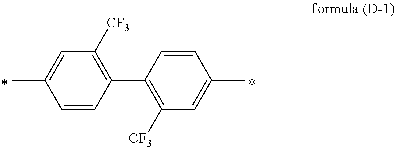

In formula (D-1), * represents a bonding position.

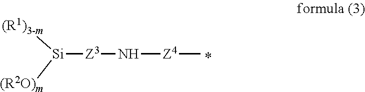

In formula (3), Z³ is an alkylene group, an alkenylene group, an alkynylene group, a cycloalkylene group, a cycloalkenylene group, or an arylene group, R¹ and R² are an alkyl group, an alkenyl group, an alkynyl group, a cycloalkyl group, or a phenyl group, respectively, m is an integer of 1 to 3, Z⁴ is a single bond or a structure represented by formula (3-a), and * represents a bonding position.

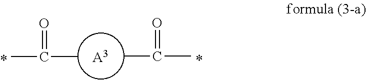

In formula (3-a), A³ is a divalent organic group, and * represents a bonding position.

In an embodiment of the invention, A¹ is

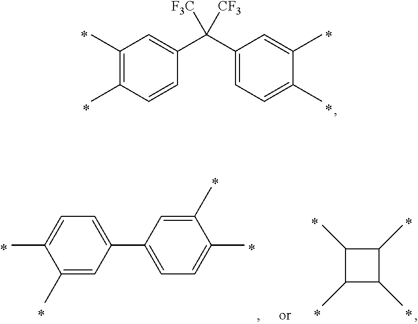

wherein * represents a bonding position.

In an embodiment of the invention, A² and A³ are respectively

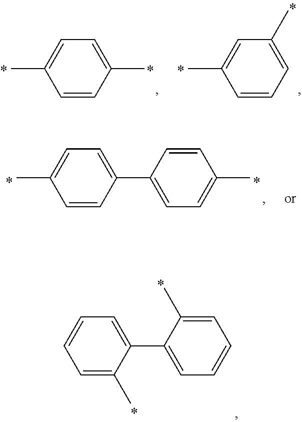

wherein * represents a bonding position.

In an embodiment of the invention, in formula (1) and formula (2), when D¹ and D² are not the structure represented by formula (D-1), D¹ and D² are respectively

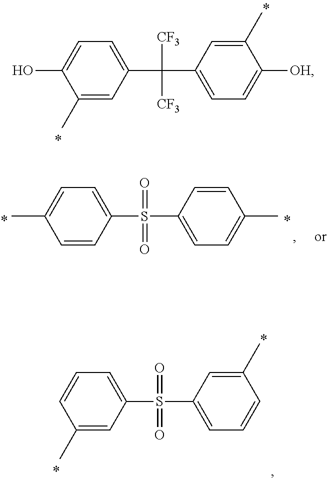

wherein * represents a bonding position.

A composition for a thin film of the invention includes the poly(amide-imide) copolymer above.

In an embodiment of the invention, the composition for the thin film further includes an end-capping isocyanate. The end-capping isocyanate has a structure represented by formula (4).

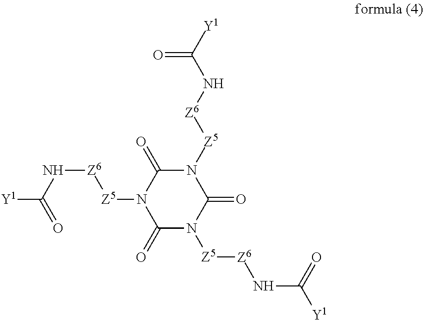

In formula (4), Z⁵ is a single bond or a carbonyl group, Z⁶ is a substituted or unsubstituted alkylene group or a substituted or unsubstituted cycloalkylene group, Y¹ is

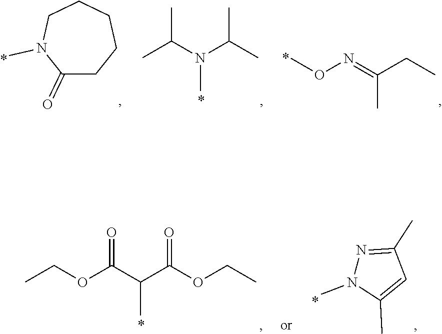

wherein * represents a bonding position.

A thin film of the invention is formed by the poly(amide-imide) copolymer above or the composition for the thin film above.

Based on the above, a poly(amide-imide) copolymer of the invention is synthesized by polymerization, dehydration cyclization, and hydrolysis condensation of an aromatic diamine monomer, a diacyl chloride monomer, a tetracarboxylic dianhydride monomer, and a silane compound having an alkoxy group, wherein based on a usage amount of 100 mol % of the aromatic diamine monomer, a usage amount of the 2,2′-bis(trifluoromethyl)benzidine in the aromatic diamine monomer is 70 mol % or more. Therefore, the poly(amide-imide) copolymer or the composition for the thin film having the poly(amide-imide) copolymer may be smoothly formed into a film and the prepared thin film has good light transmittance, yellowing resistance, and hardness.

In order to make the aforementioned features and advantages of the disclosure more comprehensible, embodiments accompanied with FIGURES are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a reaction flowchart of a poly(amide-imide) copolymer according to an embodiment of the invention.

### DESCRIPTION OF THE EMBODIMENTS

The terminology used herein is for the purpose of describing particular example embodiments only and is not intended to be limiting of the present disclosed subject matter. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof

### <Poly(Amide-Imide) Copolymer>

A poly(amide-imide) copolymer according to the present embodiment includes an amide structural unit and an imide structural unit, wherein the amide structural unit and the imide structural unit are randomly arranged in the poly(amide-imide) copolymer. The amide structural unit is formed by reacting an aromatic diamine monomer (a1) and a diacyl chloride monomer (a2). The imide structural unit is formed by reacting the aromatic diamine monomer (a1) and a tetracarboxylic dianhydride monomer (a3). The aromatic diamine monomer (a1) forming the amide structural unit may be the same as or different from the aromatic diamine monomer (a1) forming the imide structural unit. By including the amide structural unit and the imide structural unit in the copolymer, a thin film formed by the poly(amide-imide) copolymer may have good light transmittance, yellowing resistance, and hardness.

More specifically, the poly(amide-imide) copolymer is formed by polymerization, dehydration cyclization, and hydrolysis condensation of the aromatic diamine monomer (a1), the diacyl chloride monomer (a2), the tetracarboxylic dianhydride monomer (a3), and a silane compound (a4) having an alkoxy group. The silane compound having the alkoxy group is used as an end-capping agent. Next, the various monomers are described in detail.

### Aromatic Diamine Monomer (a1)

The aromatic diamine monomer (a1) includes 2,2′-bis(trifluoromethyl)benzidine (TFMB). Based on a usage amount of 100 mol % of the aromatic diamine monomer (a1), the usage amount of the TFMB is 70 mol % or more, preferably 80 mol % or more, and more preferably 90 mol % or more. When the usage amount of the TFMB is in the above range, the poly(amide-imide) copolymer or a composition for a thin film having the poly(amide-imide) copolymer may be smoothly formed into a film and the prepared thin film has good light transmittance, yellowing resistance, and hardness, and a film may not be formed when the usage amount of the TFMB is less than 70 mol %.

In other embodiments, the aromatic diamine monomer (a1) may further include other aromatic diamine monomers. Other aromatic diamine monomers include at least one of 2,2′-bis(3-amino-4-hydroxyphenyl)hexafluoropropane (bis APAF), 4,4′-diaminodiphenylsulfone (4,4′-DDS), and 3,3′-diaminodiphenylsulfone (3,3′-DDS). However, the invention is not limited thereto, and in other embodiments, other aromatic diamine monomers may also be selected from other suitable diamine monomers.

Based on a total usage amount of 100 parts by mole of the diacyl chloride monomer (a2) and the tetracarboxylic dianhydride monomer (a3), the usage amount of the aromatic diamine monomer (a1) is between 70 parts by mole and 100 parts by mole, preferably between 80 parts by mole and 100 parts by mole, and more preferably between 90 parts by mole and 98 parts by mole.

### Diacyl Chloride Monomer (a2)

The diacyl chloride monomer (a2) includes at least one of terephthaloyl chloride (TPC), isophthaloyl dichloride (IPC), 4,4′-diphenoyl chloride, and 2,2′-diphenoyl chloride. Additionally, in other embodiments, the diacyl chloride monomer (a2) may also include other suitable diacyl chloride monomers.

Based on a total usage amount of 100 parts by mole of the diacyl chloride monomer (a2) and the tetracarboxylic dianhydride monomer (a3), the usage amount of the diacyl chloride monomer (a2) is between 30 parts by mole and 70 parts by mole, preferably between 40 parts by mole and 70 parts by mole, and more preferably between 40 parts by mole and 65 parts by mole.

### Tetracarboxylic Dianhydride Monomer (a3)

The tetracarboxylic dianhydride monomer (a3) includes at least one of 4,4′-(hexafluoroisopropylidene)diphthalic anhydride (6FDA), 3,3′,4,4′-biphenyltetracarboxylic dianhydride (BPDA), and 1,2,3,4-cyclobutanetetracarboxylic dianhydride (CBDA). However, the invention is not limited thereto, and in other embodiments, the tetracarboxylic dianhydride monomer (a3) may also be selected from other suitable monomers.

Based on a total usage amount of 100 parts by mole of the diacyl chloride monomer (a2) and the tetracarboxylic dianhydride monomer (a3), the usage amount of the tetracarboxylic dianhydride monomer (a3) is between 30 parts by mole and 70 parts by mole, preferably between 30 parts by mole and 60 parts by mole, and more preferably between 35 parts by mole and 60 parts by mole.

### Silane Compound (a4) Having Alkoxy Group

The silane compound (a4) having the alkoxy group is used as an end-capping agent of the poly(amide-imide) copolymer. The silane compound (a4) having the alkoxy group includes at least one of a silane compound (a4-1) having an alkoxy group and an amine group and a silane compound (a4-2) having an alkoxy group and an isocyanate group. It is noteworthy that the silane compound (a4-1) having the alkoxy group and the amine group and the silane compound (a4-2) having the alkoxy group and the isocyanate group may respectively be reacted with an acyl chloride group derived from the diacyl chloride monomer (a2) located at a terminal of the poly(amide-imide) copolymer via an amine group and an isocyanate group to be bonded to the terminal of the poly(amide-imide) copolymer to form a structure of a silane terminal.

The silane compound (a4-1) having the alkoxy group and the amine group includes at least one of (3-aminopropyl)triethoxysilane (APTES) and (3-aminopropyl)trimethoxysilane (APTMS). However, the invention is not limited thereto, and in other embodiments, the silane compound (a4-1) having the alkoxy group and the amine group may also be selected from other suitable monomers.

The silane compound (a4-2) having the alkoxy group and the isocyanate group includes 3-isocyanatopropyltriethoxysilane. However, the invention is not limited thereto, and in other embodiments, the silane compound (a4-2) having the alkoxy group and the isocyanate group may also be selected from other suitable monomers.

When the silane compound (a4) having the alkoxy group is added as an end-capping agent of the poly(amide-imide) copolymer in the reaction of the poly(amine-imide) copolymer, the prepared thin film has good light transmittance, yellowing resistance, and hardness, and thin films prepared without the addition of the end-capping agent have poor light transmittance and yellowing resistance.

Based on a total usage amount of 100 parts by mole of the diacyl chloride monomer (a2) and the tetracarboxylic dianhydride monomer (a3), the usage amount of the silane compound (a4) having the alkoxy group is between 5 parts by mole and 20 parts by mole, preferably between 6.5 parts by mole and 13.5 parts by mole, and more preferably between 7.5 parts by mole and 12.5 parts by mole.

### <Preparation of Poly(Amide-Imide) Copolymer>

The aromatic diamine monomer (a1) and the tetracarboxylic dianhydride monomer (a3) may be first polymerized to form polyamic acid. Next, the silane compound (a4) having the alkoxy group and the diacyl chloride monomer (a2) are added, and the mixture is subjected to a hydrolysis condensation reaction to form a poly(amic acid-amide) copolymer including an amic acid structural unit and an amide structural unit and having a structure of a silane terminal. Then, the amic acid structural unit in the poly(amic acid-amide) copolymer is further subjected to a dehydration cyclization reaction to form a poly(amide-imide) copolymer including an amide structural unit and an imide structural unit and having a structure of a silane terminal.

The polymerization reaction, the hydrolysis condensation reaction, and the dehydration cyclization reaction may be performed in the presence of a solvent. The solvent is, for example, N-methylpyrrolidone, but the invention is not limited thereto, and other solvents may also be selected as needed.

The temperature of the polymerization reaction may be 5° C. to 40° C. and the time thereof may be 4 hours to 12 hours. The temperature of the hydrolysis condensation reaction may be 20° C. to 85° C., and the time thereof may be 10 hours to 14 hours.

The dehydration cyclization reaction may be performed using a high-temperature cyclization method or a chemical cyclization method.

The temperature of the high-temperature cyclization method may be 150° C. to 180° C. and the time thereof may be 4 hours to 8 hours.

In the chemical cyclization method, a dehydrating agent and a catalyst may be added to the reaction solution, and the reaction may be performed at a temperature of 70° C. to 100° C. for 2 hours to 5 hours. The dehydrating agent is, for example, an acid anhydride such as acetic anhydride, propionic anhydride, or trifluoroacetic anhydride, but the invention is not limited thereto, and other dehydrating agents may also be selected as needed. The catalyst is, for example, a tertiary amine such as triethylamine, pyridine, or lutidine, but the invention is not limited thereto, and other catalysts may also be selected as needed.

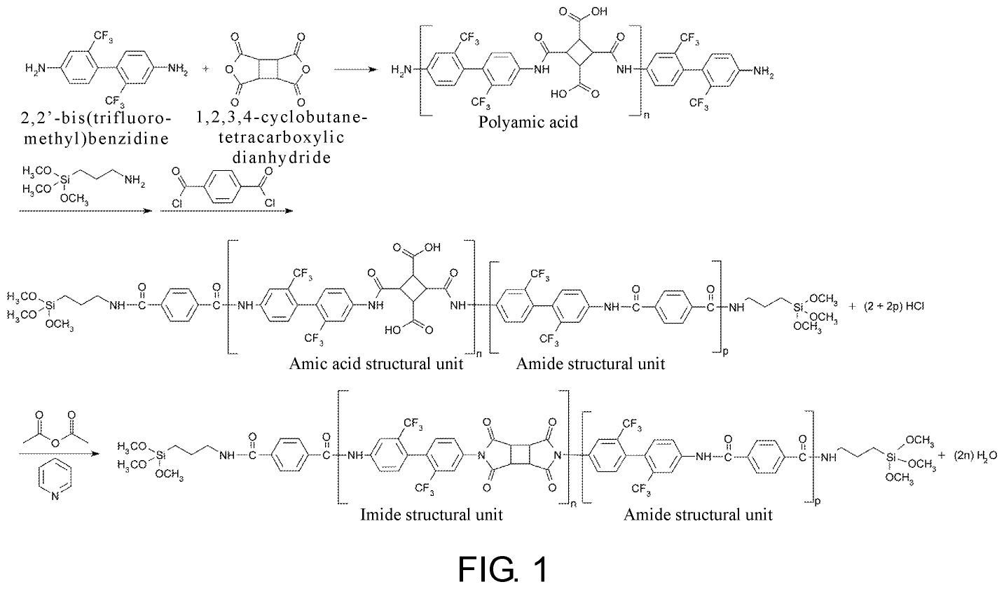

For example, a reaction flowchart in which the poly(amide-imide) copolymer is formed by a chemical cyclization method and reacting 2,2′-bis(trifluoromethyl)benzidine (TFMB) used as an aromatic diamine monomer, terephthaloyl chloride (TPC) used as a diacyl chloride monomer, 1,2,3,4-cyclobutanetetracarboxylic dianhydride (CBDA) used as a tetracarboxylic dianhydride monomer, and (3-aminopropyl)trimethoxysilane (APTMS) used as a silane compound having an alkoxy group is provided in FIG. 1.

In the reaction flowchart shown in FIG. 1, 2,2′-bis(trifluoromethyl)benzidine (TFMB) and 1,2,3,4-cyclobutanetetracarboxylic dianhydride (CBDA) are formed by polymerization to form polyamic acid including a plurality of amic acid structural units, wherein the number “n” of the amic acid structural units varies depending on the amount of the monomer added. Next, the above is reacted with (3-aminopropyl)trimethoxysilane (APTMS) and terephthaloyl chloride (TPC) to form a poly(amic acid-amide) copolymer including a plurality of amic acid structural units and a plurality of amide structural units, wherein the number “p” of the amide structural units is 1 or more, and varies depending on the amount of the monomer added. Lastly, the poly(amic acid-amide) copolymer is subjected to a dehydration cyclization reaction in the presence of acetic anhydride and pyridine to form a poly(amide-imide) copolymer having a silane terminal. It is to be noted that, in the present embodiment, the poly(amide-imide) copolymer includes a block formed by n imide structural units and a block formed by p amide structural units, but the invention is not limited thereto, and the amide structural units and the imide structural units may also be randomly arranged in the poly(amide-imide) copolymer. For example, the poly(amide-imide) copolymer may include a plurality of imide structural unit groups and a plurality of amide structural unit groups, wherein each of the imide structural unit groups in the plurality of imide structural unit groups includes at least one imide structural unit, and each of the amide structural unit groups in the plurality of amide structural unit groups includes at least one amide structural unit. In an embodiment, any imide structural unit group in the plurality of imide structural unit groups may be interspersed between any two adjacent amide structural unit groups in the plurality of amide structural unit groups such that the imide structural unit groups and the amide structural unit groups are staggered. In another embodiment, any amide structural unit group in the plurality of amide structural unit groups may also be interspersed between any two adjacent imide structural unit groups in the plurality of imide structural unit groups such that the amide structural unit groups and the imide structural unit groups are staggered.

More specifically, the poly(amide-imide) copolymer includes a structural unit represented by formula (1), a structural unit represented by formula (2), a structural unit represented by formula (3), and a silicon-oxygen-silicon bond. Next, the structures represented by (1), formula (2), and formula (3), and the silicon-oxygen-silicon bond are described in detail.

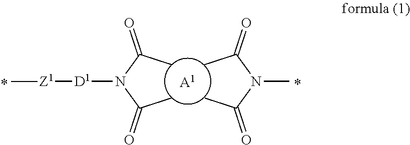

In formula (1), A¹ is a tetravalent organic group, D¹ is a divalent organic group, Z¹ is a single bond or —NH—; and * represents a bonding position.

Further, the tetravalent organic group represented by A¹ may be derived from the tetracarboxylic dianhydride monomer. In an embodiment, A¹ is preferably

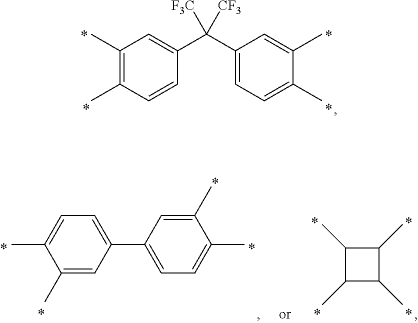

wherein * represents a bonding position.

The divalent organic group represented by D¹ may be derived from the aromatic diamine monomer. In an embodiment, D¹ is preferably a structure represented by formula (D-1).

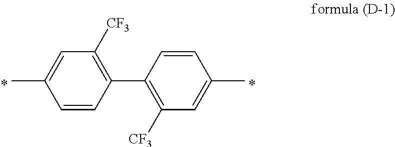

In formula (D-1), * represents a bonding position.

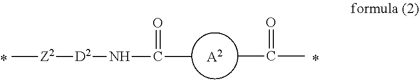

In formula (2), A² is a divalent organic group, D² is a divalent organic group, Z² is a single bond or —NH—, and * represents a bonding position.

Further, the divalent organic group represented by A² may be derived from the diacyl chloride monomer. In an embodiment, A² is preferably

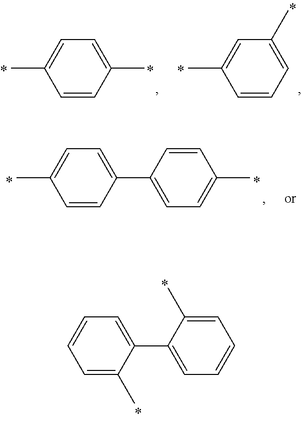

wherein * represents a bonding position.

The divalent organic group represented by D² may be derived from the aromatic diamine monomer. In an embodiment, D² is preferably a structure represented by formula (D-1).

It is to be noted that, in formula (1) and formula (2), at least one of D¹ and D² is a structure represented by formula (D-1). When D¹ and D² are not the structure represented by formula (D-1), D¹ and D² are respectively

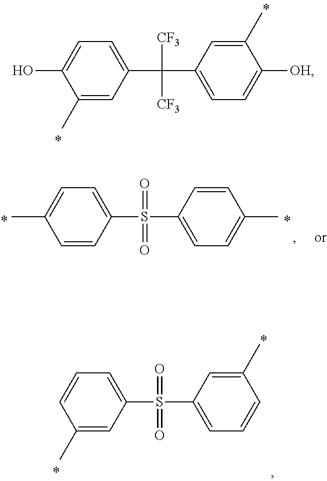

wherein * represents a bonding position.

Based on a total amount of 100 mol % of D¹ and D² in the poly(amide-imide) copolymer, the amount of the structure represented by formula (D-1) is 70 mol % or more, preferably 80 mol % or more, and more preferably 90 mol % or more. When the amount of the structure represented by formula (D-1) is within the above range, the poly(amide-imide) copolymer or the composition for the thin film having the poly(amide-imide) copolymer may be smoothly formed into a film, and the prepared thin film has good light transmittance, yellowing resistance, and hardness, and when the structure represented by formula (D-1) is less than 70 mol %, a film may not be formed.

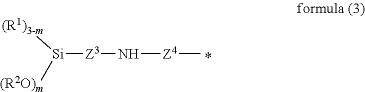

In formula (3),

Z³ is an alkylene group, an alkenylene group, an alkynylene group, a cycloalkylene group, a cycloalkenylene group, or an arylene group, preferably an alkylene group, and more preferably a C1 to C11 alkylene group;

R¹ and R² are respectively an alkyl group, an alkenyl group, an alkynyl group, a cycloalkyl group, or a phenyl group, and are preferably respectively a C1 to C20 alkyl group, a C2 to C20 alkenyl group, a C2 to C20 alkynyl group, a C3 to C20 cycloalkyl group, or a phenyl group, more preferably respectively a C1 to C5 alkyl group;

m is an integer of 1 to 3,

Z⁴ is a single bond or a structure represented by formula (3-a),

* represents a bonding position.

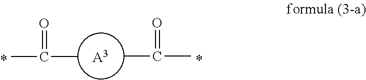

In formula (3-a), A³ is a divalent organic group, and * represents a bonding position.

The divalent organic group represented by A³ may be derived from the diacyl chloride monomer. In an embodiment, A³ is preferably

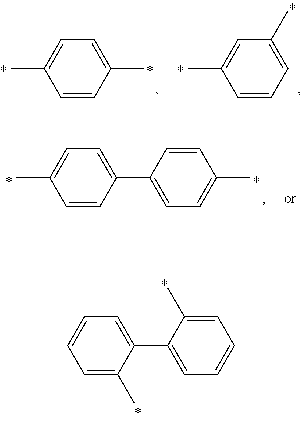

wherein * represents a bonding position.

A³ in formula (3-a) and A² in formula (2) may be the same or different divalent organic groups.

When the terminal of the poly(amide-imide) copolymer is the structural unit represented by formula (3), the thin film prepared by the poly(amide-imide) copolymer has good light transmittance, yellowing resistance, and hardness, and a thin film prepared by a poly(amide-imide) copolymer having a terminal that is not the structural unit represented by formula (3) has poor light transmittance and yellowing resistance.

Further, when Z¹ in formula (1) is a single bond, formula (1) may be bonded to each other. Further, when Z¹ in formula (1) is a single bond, formula (1) is a structural unit represented by formula (1-1). The structural unit represented by formula (1-1) is comparable to the structural unit contained in the imide structural unit.

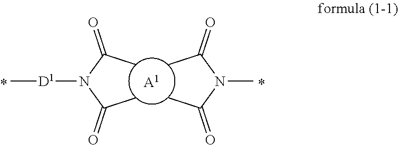

In formula (1-1), the groups represented by A¹ and D¹ are the same as the groups represented by A¹ and D¹ in formula (1) and are not repeated herein.

When Z¹ in formula (1) is —NH—, formula (1) may be bonded to a carbonyl group having a “*” at one terminal in formula (2) or a residue derived from diacyl chloride via Z¹. Further, when Z¹ in formula (1) is —NH—, formula (1) is bonded to formula (2) or between the residues derived from diacyl chloride to form the structural unit represented by formula (1-2). The structure represented by formula (1-2) is comparable to a structural unit formed after a residue derived from diamine in the imide structural unit and the residue derived from diacyl chloride in the amide structural unit or the residue derived from diacyl chloride are bonded.

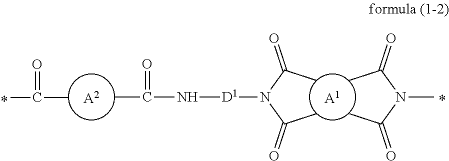

In formula (1-2), the groups represented by A¹ and D¹ are the same as the groups represented by A¹ and D¹ in formula (1) and the group represented by A² is the same as the group represented by A² in formula (2) and are not repeated herein.

When Z² in formula (2) is a single bond, formula (2) may be bonded to a nitrogen atom of the imide group in formula (1) via Z² to form a structural unit represented by formula (2-1). The structural unit represented by formula (2-1) is comparable to the structural unit formed after the residue derived from diamine in the amide structural unit and a residue derived from tetracarboxylic dianhydride in the imide structural unit are bonded.

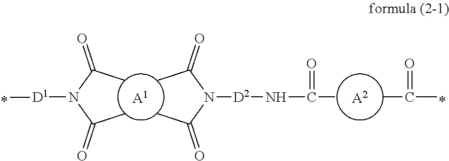

In formula (2-1), the groups represented by A¹ and D¹ are the same as the groups represented by A¹ and D¹ in formula (1), and the groups represented by A² and D² are the same as the groups represented by A² and D² in formula (2) and are not repeated herein.

When Z² in formula (2) is —NH—, formula (2) may be bonded to each other. Further, when Z² in formula (2) is —NH—, formula (2) is a structural unit represented by formula (2-2). The structural unit represented by formula (2-2) is comparable to the structural unit contained in the amide structural unit.

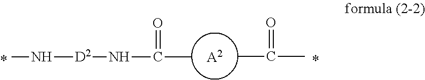

In formula (2-2), the groups represented by A² and D² are the same as the groups represented by A² and D² in formula (2) and are not repeated herein.

When Z⁴ in formula (3) is a single bond, formula (3) may be bonded to a carbonyl group having a “s” at one terminal in formula (2) via Z⁴. Further, when Z⁴ in formula (3) is a single bond, formula (3) is a structural unit represented by formula (3-1). The structural unit represented by formula (3-1) is comparable to a structural unit formed after a residue derived from a silane compound having an alkoxy group and the residue derived from diacyl chloride in the amide structural unit are bonded.

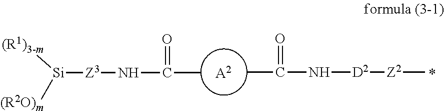

In formula (3-1), the groups represented by A² and D² are the same as the groups represented by A² and D² in formula (2), the groups represented by Z³, R¹, and R² are the same as the groups represented by Z³, R¹ and R² in formula (3), and the numerical range of m is the same as the numerical range of m in formula (3), and are not repeated herein.

When Z⁴ in formula (3) is a structure represented by formula (3-a), formula (3) may be bonded to Z₁ in formula (1) when Z₁ is —NH— via Z⁴ to form a structural unit represented by formula (3-2). The structural unit represented by formula (3-2) is comparable to the structural unit formed after the residue derived from the silane compound having the alkoxy group is bonded to the residue derived from diamine in the imide structural unit via the residue derived from diacyl chloride.

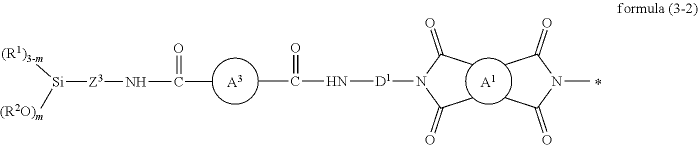

In formula (3-2), the groups represented by A² and D² are the same as the groups represented by A² and D² in formula (2), the groups represented by Z³, R¹, and R² are the same as the groups represented by Z³, R¹, and R², and the numerical range of m is the same as the numerical range of m in formula (3), and are not repeated herein.

The silicon-oxygen-silicon bond is formed by a hydrolysis condensation reaction between poly(amide-imide) copolymers via an alkoxy group. A plurality of poly(amide-imide) copolymers form an inorganic network crosslinked structure via a silicon-oxygen-silicon bond. Therefore, the poly(amide-imide) copolymers have better mechanical properties.

When the poly(amide-imide) copolymers are respectively allowed to stand at 25° C. and 45° C. for one month, the variation in viscosity is within the range of ±1%. That is, the poly(amide-imide) copolymers have good stability.

The weight-average molecular weight of the poly(amide-imide) copolymers is between 150,000 and 500,000, preferably between 150,000 and 400,000, and more preferably between 170,000 and 300,000. When the weight-average molecular weight of the poly(amide-imide) copolymers is between 150,000 and 500,000, the yellowing resistance of the thin film may be further improved.

### <Composition for Thin Film>

The composition for the thin film includes the poly(amide-imide) copolymer in any of the above embodiments. Further, the composition for the thin film may include a solvent, and may optionally include an end-capping isocyanate. Further, the method of forming the composition for the thin film is not particularly limited, and is for example, continuously stirring using a stirring device until each component in the composition for the thin film is uniformly dispersed.

The solvent is not particularly limited as long as the composition for the thin film may be uniformly mixed and does not react with each component in the composition for the thin film. The solvent is, for example, dimethylacetamide (DMAc). Based on 100 parts by weight of the poly(amide-imide) copolymer, the usage amount of the solvent is between 200 parts by weight and 900 parts by weight, preferably between 400 parts by weight and 750 parts by weight, and more preferably between 500 parts by weight and 700 parts by weight.

The composition for the thin film preferably includes an end-capping isocyanate. The end-capping isocyanate has a structure represented by formula (4).

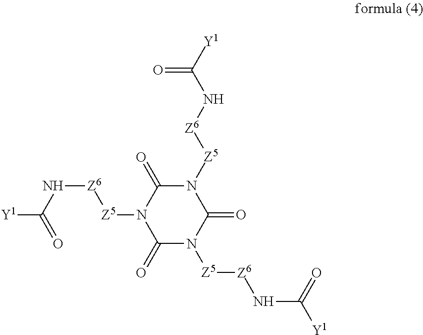

In formula (4),

Z⁵ is a single bond or a carbonyl group;

Z⁶ is a substituted or unsubstituted alkylene group or a substituted or unsubstituted cycloalkylene group;

Y¹ is

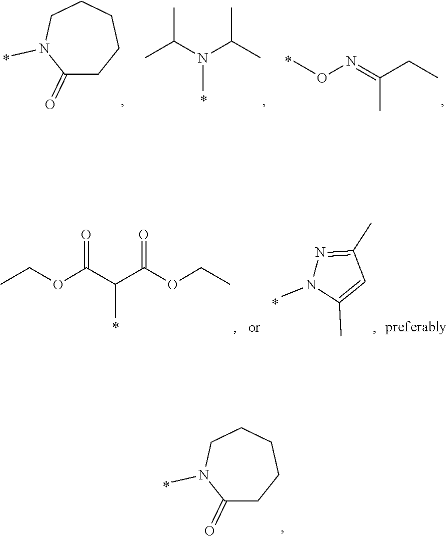

wherein * represents a bonding position.

When Z⁵ is a single bond, Z⁶ is preferably an unsubstituted alkylene group, more preferably a hexylene group. When Z⁵ is a carbonyl group, Z⁶ is preferably a substituted cycloalkylene group, more preferably

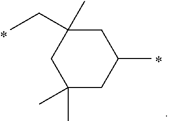

The structure represented by formula (4) is preferably a structure represented by formula (4-1).

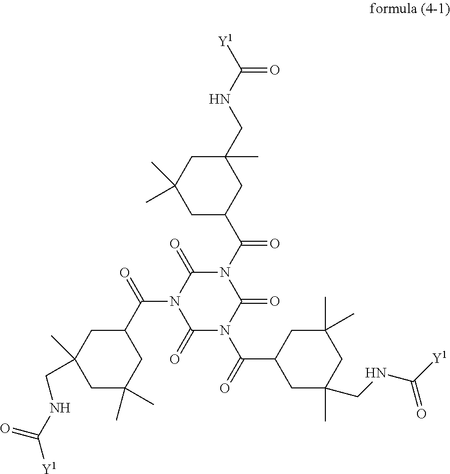

In formula (4-1), Y¹ is

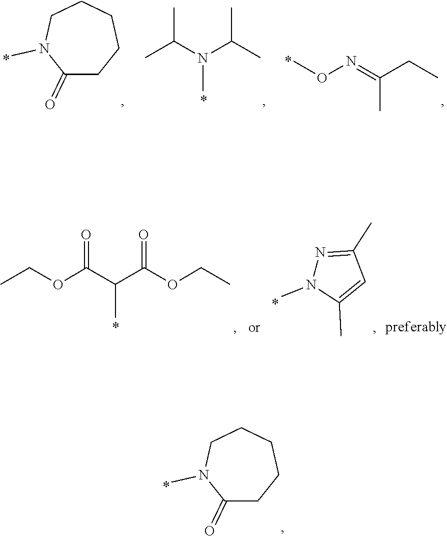

wherein * represents a bonding position.

Further, specific examples of the end-capping isocyanate include a compound represented by formula (4-1-1), a compound represented by formula (4-1-2), a compound represented by formula (4-1-3), a compound represented by formula (4-1-4), a compound represented by formula (4-1-5), a compound represented by formula (4-2), or a combination thereof, and the end-capping isocyanate is preferably a compound represented by (4-1-1). When the compound represented by formula (4-1-1) is used as the end-capping isocyanate, the light transmittance and yellowing resistance of the thin film may be further improved.

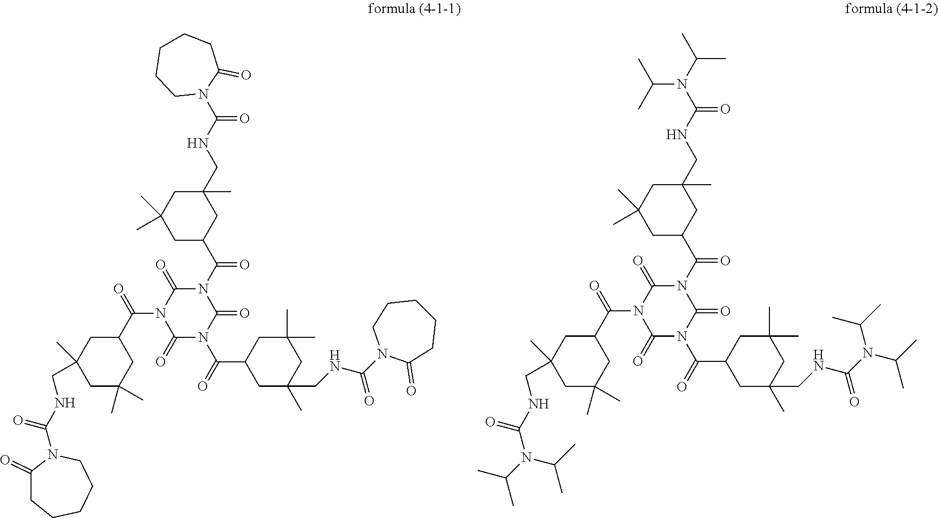 [SMILES: CC1(C)CC(C(=O)n2c(=O)n(C(=O)C3CC(C)(C)CC(C)(CNC(=O)N4CCCCCC4=O)C3)c(=O)n(C(=O)C3CC(C)(C)CC(C)(CNC(=O)N4CCCCCC4=O)C3)c2=O)CC(C)(CNC(=O)N2CCCCCC2=O)C1 ; CC(C)N(C(=O)NCC1(C)CC(C(=O)n2c(=O)n(C(=O)C3CC(C)(C)CC(C)(CNC(=O)N(C(C)C)C(C)C)C3)c(=O)n(C(=O)C3CC(C)(C)CC(C)(CNC(=O)N(C(C)C)C(C)C)C3)c2=O)CC(C)(C)C1)C(C)C]

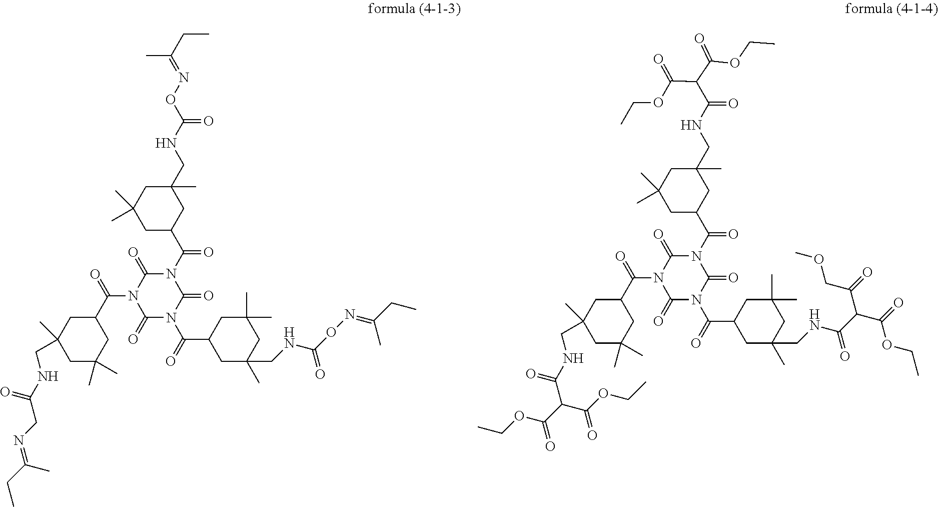 [SMILES: CC/C(C)=N/CC(=O)NCC1(C)CC(C(=O)n2c(=O)n(C(=O)C3CC(C)(C)CC(C)(CNC(=O)O/N=C(\C)CC)C3)c(=O)n(C(=O)C3CC(C)(C)CC(C)(CNC(=O)O/N=C(\C)CC)C3)c2=O)CC(C)(C)C1 ; CCOC(=O)C(C(=O)COC)C(=O)NCC1(C)CC(C(=O)n2c(=O)n(C(=O)C3CC(C)(C)CC(C)(CNC(=O)C(C(=O)OCC)C(=O)OCC)C3)c(=O)n(C(=O)C3CC(C)(C)CC(C)(CNC(=O)C(C(=O)OCC)C(=O)OCC)C3)c2=O)CC(C)(C)C1]

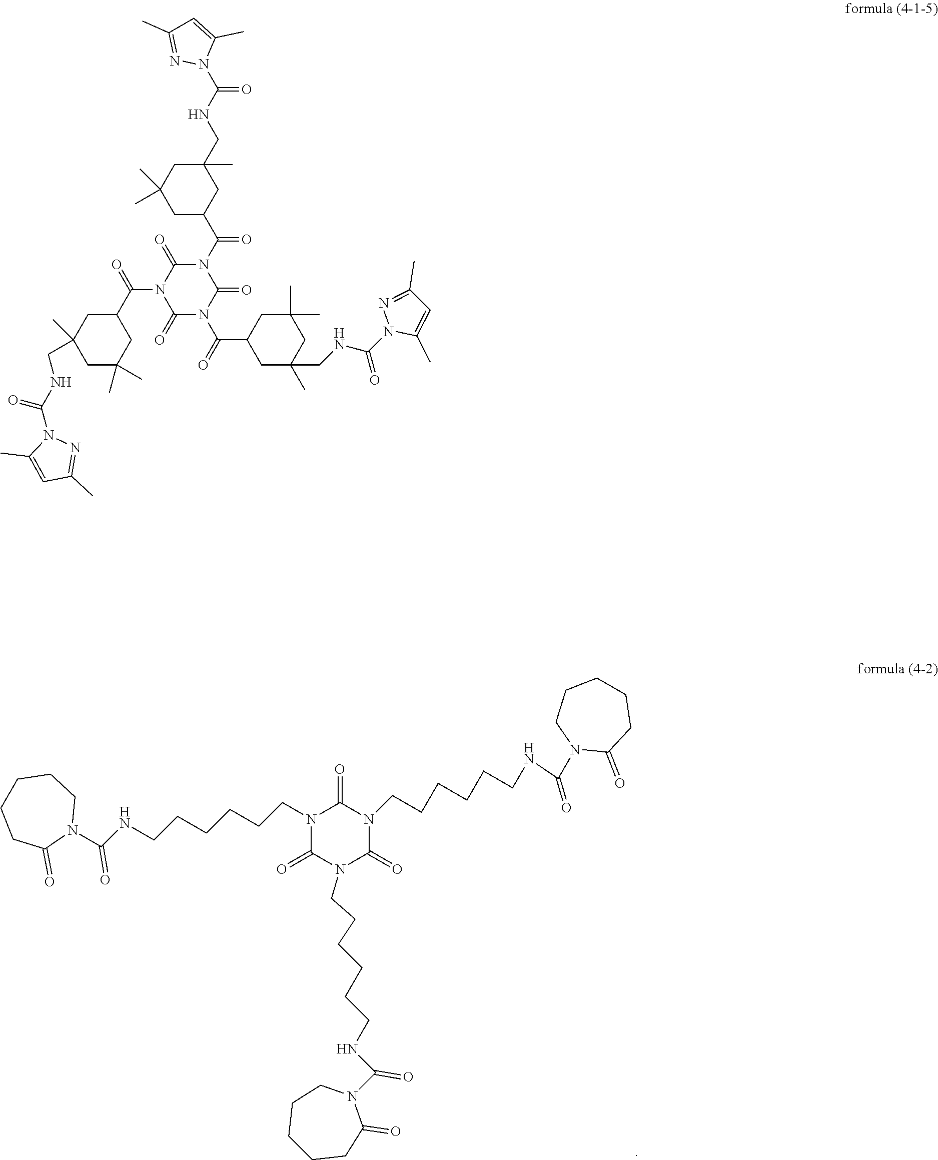

Based on 100 parts by weight of the poly(amide-imide) copolymer, the usage amount of the end-capping isocyanate is between 5 parts by weight and 30 parts by weight, preferably between 5 parts by weight and 15 parts by weight, and more preferably between 5 parts by weight and 10 parts by weight.

When the end-capping isocyanate is added to the composition for the thin film, the yellowing resistance of the thin film may be further improved while maintaining good optical performance.

### <Thin Film>

The thin film may be formed of the above poly(amide-imide) copolymer or the above composition for the thin film.

The thin film is prepared by, for example, coating the above poly(amide-imide) copolymer or the composition for the thin film on a substrate, followed by drying.

The substrate is not particularly limited and may be selected as needed. The substrate is, for example, an alkali-free glass, soda lime glass, hard glass, or quartz glass.

The coating method is not particularly limited and may be selected as needed. The coating method is, for example, a flow method, a roll coating method, a bar coating method, a spray coating method, an air knife coating method, a spin coating method, a flow coating method, a curtain coating method, or a dipping method.

The drying method of is not particularly limited and may be selected as needed. The drying method is, for example, heating a substrate coated with the poly(amide-imide) copolymer or the composition for the thin film using an oven or a hot plate to remove the solvent. The drying temperature may be 200° C. to 300° C. and the time may be 20 minutes to 1 hour. The drying temperature and time may also be selected as needed, and baking may be performed in a gradient heating manner.

In an embodiment, according to the American Society for Testing Materials (ASTM) E313, a thin film having a thickness of 45 to 55 μm has a transmittance of 89% or more at a wavelength of 550 nm and a yellowness index of 3.5 or less. Further, the thin film having a thickness of 45 to 55 μm has a pencil hardness of greater than 3B, preferably F to H.

Examples are provided below to more specifically describe the invention. Although the following experiments are described, the materials used, the amounts and ratios thereof, the processing details, the processing flow, and the like may be suitably changed without departing from the scope of the invention. Therefore, the invention should not be construed restrictively based on the experiments described below.

Synthesis examples 1 to 15 of the poly(amide-imide) copolymer are described below.

### Synthesis Example 1

In a 1 L reactor provided with a stirrer, a nitrogen injection device, a drip funnel, a temperature regulator, and a condenser tube, 669 g of N-methyl-2-pyrrolidone (NMP) was added to the reactor while nitrogen gas was introduced thereto. Next, after the temperature of the reactor was set to 25° C., 53.49 g (0.167 mol) of 2,2′-bis(trifluoromethyl)benzidine (TFMB) was dissolved in NMP, and the resulting solution was maintained at 25° C. Then, 2.59 g (0.009 mol) of 3,3′,4,4′-biphenyltetracarboxylic dianhydride (BPDA), 11.72 g (0.026 mol) of 4,4′-(hexafluoroisopropylidene)diphthalic anhydride (6FDA), and 6.90 g (0.035 mol) of 1,2,3,4-cyclobutanetetracarboxylic dianhydride (CBDA) were added, and stirring was performed for 2 to 4 hours such that the components were dissolved and reacted. Next, the temperature of the solution was maintained at 0 to 5° C., and then 3.89 g (0.018 mol) of (3-aminopropyl)triethoxysilane (APTES) was added, and the mixture was uniformly stirred. Next, 19.63 g (0.097 mol) of terephthaloyl chloride (TPC) and 1.78 g (0.009 mol) of isophthaloyl dichloride (IPC) were added and the mixture was reacted at 25° C. for 12 hours to obtain a solution of a poly(amide-imide) copolymer having a solid content of 13 wt %.

Next, 13.89 g of pyridine and 18.29 g of acetic anhydride (Ac₂O) were added to the solution of the poly(amide-imide) copolymer. After stirring uniformly, the mixture was stirred at 85° C. for 4 hours. Next, the reaction solution was cooled to room temperature and precipitated using 5 L of ethanol. The precipitated solid was dried at 60° C. for 12 hours to obtain 94 g of a poly(amide-imide) copolymer in solid form. The weight-average molecular weight of the poly(amide-imide) copolymer was 172,431 as measured by gel permeation chromatography (GPC).

### Synthesis Examples 2 to 15

The preparation methods of Synthesis examples 2 to 15 were the same as the preparation method of Synthesis example 1, except that the usage amount of each component and the type thereof were changed. The composition of each synthesis example, the usage amount thereof, and the weight-average molecular weight thereof are shown in Table 1.

TABLE 1
(unit: parts by mole)

| | | | | | | | | | | | | Diacyl | | Weight- |
|---|---|---|---|---|---|---|---|---|---|---|---|---|---|---|
| | | Aromatic diamine | | | | | | | Tetracarboxylic dianhydride | | | chloride | | average |
| | Synthesis | monomer | | | End-capping agent | | | | monomer | | | monomer | | molecular |
| Copolymer | example | TFMB | ODA | FDA | APTES | APTMS | Alink25 | Aniline | CBDA | 6FDA | BPDA | TPC | IPC | weight |
| PAI | 1 | 95 | — | — | 10 | — | — | — | 20 | 15 | 5 | 55 | 5 | 172,431 |
| | 2 | 92.5 | — | — | 15 | — | — | — | 20 | 15 | 5 | 55 | 5 | 164,442 |
| | 3 | 90 | — | — | 20 | — | — | — | 20 | 15 | 5 | 55 | 5 | 118,064 |
| | 4 | 95 | — | — | 10 | — | — | — | 28 | 10 | 2 | 55 | 5 | 166,656 |
| | 5 | 95 | — | — | 10 | — | — | — | 25 | 15 | — | 55 | 5 | 156,655 |
| | 6 | 100 | — | — | — | — | — | — | 20 | 15 | 5 | 55 | 5 | 124,598 |
| | 7 | 97.5 | — | — | 5 | — | — | — | 20 | 15 | 5 | 55 | 5 | 142,103 |
| | 8 | 95 | — | — | — | 10 | — | — | 20 | 15 | 5 | 55 | 5 | 176,214 |
| | 9 | 95 | — | — | — | — | 10 | — | 20 | 15 | 5 | 55 | 5 | 157,589 |
| PA | 10 | 90 | — | — | 20 | — | — | — | — | — | — | 70 | 30 | 103,669 |
| PI | 11 | 100 | — | — | — | — | — | — | 40 | 50 | 10 | — | — | 281,643 |
| PAI | 12 | 45 | 50 | — | 10 | — | — | — | 20 | 15 | 5 | 55 | 5 | 100,511 |
| | 13 | 65 | 30 | — | 10 | — | — | — | 20 | 15 | 5 | 55 | 5 | 154,234 |
| | 14 | 95 | — | — | — | — | — | 10 | 20 | 15 | 5 | 55 | 5 | 92,136 |
| | 15 | 70 | — | 25 | 10 | — | — | — | 20 | 15 | 5 | 55 | 5 | 177,151 |

In Table 1, the abbreviations are as follows:
PAI: poly(amide-imide) copolymer
PA: polyamide
PI: polyimide
TFMB: 2,2′-bis(trifluoromethyl)benzidine
ODA: 4,4′-diaminodiphenyl ether
FDA: 9,9-bis(4-aminophenyl)fluorene
APTES: (3-aminopropyl)triethoxysilane
APTMS: (3-aminopropyl)trimethoxysilane
Alink25: 3-isocyanatopropyltriethoxysilane
CBDA: 1,2,3,4-cyclobutanetetracarboxylic dianhydride
6FDA: 4,4′-(hexafluoroisopropylidene)diphthalic anhydride
BPDA: 3,3′,4,4′-biphenyltetracarboxylic dianhydride
TPC: terephthaloyl chloride
IPC: isophthaloyl dichloride

Next, examples and comparative examples in which a thin film is formed using the above poly(amide-imide) copolymer or the composition for the thin film are described.

### Example 1

94 g of a poly(amide-imide) copolymer in solid form was dissolved in 533 g of dimethylacetamide (DMAc) to obtain a 15 wt % solution. Then, the obtained solution was coated on a glass substrate to achieve a wet film thickness of 350 μm. Next, drying was first performed at 120° C. for 1 hour, and then drying was performed at 230° C. for 20 minutes, followed by slow cooling. Next, the obtained film was separated from the glass substrate to obtain a thin film prepared by the poly(amide-imide) copolymer and having a thickness of 50 μm.

### Examples 7, 9, 11, 13, 15, 17, 19, 21, Comparative Examples 1, 3, 5 to 9

The preparation methods of Examples 7, 9, 11, 13, 15, 17, 19, 21, and Comparative examples 1, 3, and 5 to 9 were the same as the preparation method of Example 1, except that the usage amount of each component and the type thereof were changed. The composition of each of the examples and the usage amount thereof are shown in Table 2. Further, the evaluation results of the physical properties of the thin film obtained in each of the Examples and Comparative examples are also shown in Table 2.

### Example 3

94 g of the poly(amide-imide) copolymer in solid form was dissolved in 533 g of DMAc, and then 9.4 g of the end-capping isocyanate was added. After stirring for 30 minutes, the resulting solution was coated on a glass substrate to achieve a wet film thickness of 350 μm. Next, drying was first performed at 120° C. for 1 hour, and then drying was performed at 230° C. for 20 minutes, followed by slow cooling. Next, the obtained film was separated from the glass substrate to obtain a thin film formed of the composition for the thin film having a thickness of 50 μm.

### Examples 2, 4 to 6, 8, 10, 12, 14, 16, 18, 20, Comparative Examples 2 and 4

The preparation methods of Examples 2, 4 to 6, 8, 10, 12, 14, 16, 18, 20 and Comparative Examples 2 and 4 were the same as that of Example 3 except that the usage amount of each component and the type thereof were changed. The composition of each of the examples and the usage amount thereof are shown in Table 2. The usage amount of the end-capping isocyanate in Table 2 was based on a usage amount of 100 wt % of the poly(amide-imide) copolymer. Further, the evaluation results of the physical properties of the thin film obtained in each of the Examples and Comparative examples are also shown in Table 2.

### <Measurement of Physical Properties>

### 1. Transmittance and Yellowness Index

The 50 μm thin film prepared by each of the Examples and Comparative examples was measured for transmittance at a wavelength of 550 nm and yellowness index according to the specifications of the American Society for Testing Materials (ASTM) E313. When the transmittance is 89% or more, the thin film is shown to have good light transmittance. When the yellowness index is 3.5 or less, the thin film is shown to have good yellowing resistance.

### 2. Pencil Hardness

The pencil hardness of the 50 μm thin film obtained in each of the Examples and Comparative examples was measured by the specifications of ASTM D3363. When the pencil hardness is >3B, the thin film is shown to have good hardness.

TABLE 2

| | | End-capping isocyanate | | Transmittance | | Pencil |
|---|---|---|---|---|---|---|
| | Copolymer | LS2078 | BL3272 | (%) | YI | hardness |
| Example 1 | Synthesis example 1 | — | — | 90.78 | 1.87 | F to H |
| Example 2 | | 5% | — | 90.61 | 1.77 | F to H |
| Example 3 | | 10% | — | 90.46 | 1.73 | F to H |
| Example 4 | | — | 10% | 89.58 | 2.34 | F to H |
| Example 5 | | 20% | — | 89.68 | 2.53 | F to H |
| Example 6 | | 30% | — | 89.74 | 2.67 | F to H |
| Example 7 | Synthesis example 2 | — | — | 90.34 | 3.01 | F to H |
| Example 8 | | 10% | — | 90.11 | 2.86 | F to H |
| Example 9 | Synthesis example 3 | — | — | 89.26 | 3.34 | F to H |
| Example 10 | | 10% | — | 89.64 | 3.28 | F to H |
| Example 11 | Synthesis example 4 | — | — | 90.00 | 2.05 | F to H |
| Example 12 | | 10% | — | 89.73 | 2.17 | F to H |
| Example 13 | Synthesis example 5 | — | — | 90.06 | 2.12 | F to H |
| Example 14 | | 10% | — | 90.15 | 1.97 | F to H |
| Example 15 | Synthesis example 7 | — | — | 89.08 | 3.41 | F to H |
| Example 16 | | 10% | — | 89.17 | 3.37 | F to H |
| Example 17 | Synthesis example 8 | — | — | 90.47 | 1.93 | F to H |
| Example 18 | | 10% | — | 90.25 | 1.84 | F to H |
| Example 19 | Synthesis example 9 | — | — | 89.34 | 2.2 | F to H |
| Example 20 | | 10% | — | 89.44 | 2.5 | F to H |
| Example 21 | Synthesis example 15 | — | — | 89.76 | 3.24 | F to H |
| Comparative | Synthesis example 6 | — | — | 88.99 | 3.62 | F to H |
| example 1 | | | | | | |
| Comparative | | 10% | — | 88.29 | 4.24 | F to H |
| example 2 | | | | | | |
| Comparative | Synthesis example 10 | — | — | 88.66 | 2.33 | F to H |
| example 3 | | | | | | |
| Comparative | | 10% | — | 88.81 | 2.55 | F to H |
| example 4 | | | | | | |
| Comparative | Synthesis example 11 | — | — | 90.31 | 1.85 | <6B |
| example 5 | | | | | | |
| Comparative | Synthesis example 12 | — | — | Unable to form film | | |
| example 6 | | | | | | |
| Comparative | Synthesis example 13 | — | — | Unable to form film | | |
| example 7 | | | | | | |
| Comparative | Synthesis example 10 | — | — | 88.94 | 2.14 | <3B |
| example 8 | and 11 | | | | | |
| Comparative | Synthesis example 14 | — | — | 88.62 | 3.77 | F to H |
| example 9 | | | | | | |

In Table 2, the abbreviations are as follows:
LS2078: compound represented by formula (4-1-1).
BL3272: compound represented by formula (4-2).

According to Table 2, in Examples 1 to 21 in which the usage amount of 2,2′-bis(trifluoromethyl)benzidine (TFMB) in the poly(amide-imide) copolymer was 70 mol % or more, the transmittance was 89% or more, the yellowness index was 3.5 or less, and the pencil hardness was F to H. In comparison, in Comparative examples 6 and 7 in which the usage amount of 2,2′-bis(trifluoromethyl)benzidine was less than 70 mol %, a film could not be formed. Therefore, when the usage amount of 2,2′-bis(trifluoromethyl)benzidine (TFMB) was 70 mol % or more, the poly(amide-imide) copolymer or the composition for the thin film having the poly(amide-imide) copolymer may be smoothly formed into a film and the prepared thin film had good light transmittance, yellowing resistance, and hardness, and when the usage amount of 2,2′-bis(trifluoromethyl)benzidine was less than 70 mol %, a film could not be formed.

Further, the thin film prepared by the poly(amide-imide) copolymer (PAI) (Examples 1 to 21) had a transmittance of 89% or more, a yellowness index of 3.5 or less, and a pencil hardness of F to H. In contrast, the thin films prepared by polyamide (PA), polyimide (PI), or a mixture of polyamide and polyimide (Comparative examples 3, 4, 5, and 8 respectively) had a transmittance of less than 89% or a pencil hardness of 3B or less. Therefore, the thin films prepared by the poly(amide-imide) copolymer (PAI) had good light transmittance, yellowing resistance, and hardness, and thin films formed by polyamide (PA), polyimide (PI), or a mixture of polyamide and polyimide may not meet all of the requirements of light transmittance, yellowing resistance, and hardness.

In addition, the thin films prepared by the addition of the end-capping agent to the reaction of the poly(amide-imide) copolymer (Examples 1 to 21) had a transmittance of 89% or more, a yellowness index of 3.5 or less, and a pencil hardness of F to H. In contrast, the thin films prepared without the addition of the end-capping agent had a transmittance of less than 89% and a yellowness index of 3.62. It may be seen that the thin films prepared by the addition of the end-capping agent to the reaction of the poly(amide-imide) copolymer had good light transmittance, yellowing resistance, and hardness, and the thin films prepared without the addition of the end-capping agent had por light transmission and yellowing resistance.

Further, in Example 1 (Synthesis example 1, weight-average molecular weight: 172,431) in which the weight-average molecular weight of the poly(amide-imide) copolymer was between 150,000 and 500,000, the transmittance was 89% or more, the yellow index was 3.5 or less, and the pencil hardness was F to H. In contrast, in Comparative examples 1 and 9 in which the weight-average molecular weight of the poly(amide-imide) copolymer was less than 150,000, the transmittance was less than 89%, and the yellowness index was 3.62 and 3.77, respectively. Therefore, the thin film having the poly(amide-imide) copolymer having a weight-average molecular weight between 150,000 and 500,000 had good light transmittance, yellowing resistance, and hardness.

Moreover, in Examples 1 to 21, Examples 1 to 8, 11 to 14, and 17 to 21 in which the poly(amide-imide) copolymer had a weight-average molecular weight between 150,000 and 500,000 had a yellowness index of 1.73 to 3.24, and the yellowness index of Examples 9 to 10 and 15 to 16 in which the poly(amide-imide) copolymer had a weight-average molecular weight of less than 150,000 was 3.28 to 3.41. It may be seen that when the weight-average molecular weight of the poly(amide-imide) copolymer was between 150,000 and 500,000, the yellowing resistance of the thin film may be further improved.

Further, the thin films prepared by the addition of the end-capping isocyanate to the composition for the thin film (Examples 2 to 3) had a yellowness index (1.73 to 1.77) less than the yellowness index (1.87) of the thin film in which the end-capping isocyanate was not added to the composition for the thin film (Example 1). Therefore, when the end-capping isocyanate was added to the composition for the thin film, the yellowing resistance of the thin film may be further improved while maintaining good optical performance. In addition, it may be known from the difference among the six groups of Examples 7 and 8, Examples 8 and 10, Examples 11 and 12, Examples 13 and 14, Examples 15 and 16, Examples 17 and 18, and Examples 19 and 20 that the thin films prepared by the addition of the end-capping isocyanate to the composition for the thin film may have even better yellowing resistance while maintaining good optical performance.

Further, the thin film obtained by the addition of the compound represented by formula (4-1-1) as the end-capping isocyanate to the composition for the thin film (Example 3) had both better transmittance (90.46%) and yellowness index (1.73) than the transmittance (89.58%) and the yellowness index (2.34) of the thin film prepared by the addition of the compound represented by formula (4-2) as the end-capping isocyanate to the composition for the thin film (Example 4). Therefore, when the compound represented by formula (4-1-1) is used as the end-capping isocyanate, the light transmittance and yellowing resistance of the thin film may be further improved.

Based on the above, the invention provides a poly(amide-imide) copolymer obtained by polymerization, dehydration cyclization, and hydrolysis condensation of 2,2′-bis(trifluoromethyl)benzidine and other monomers, wherein based on a usage amount of 100 mol % of the aromatic diamine monomer, the usage amount of 2,2′-bis(trifluoromethyl)benzidine is 70 mol % or more. Therefore, the poly(amide-imide) copolymer or the composition for the thin film having the poly(amide-imide) copolymer may be smoothly formed into a film and the prepared thin film has good light transmittance (optical properties), yellowing resistance, and hardness.

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

What is claimed is:

1. A poly(amide-imide) copolymer synthesized by polymerization, dehydration cyclization, and hydrolysis condensation of an aromatic diamine monomer, a diacyl chloride monomer, a tetracarboxylic dianhydride monomer, and a silane compound having an alkoxy group,
wherein the silane compound having the alkoxy group is used as an end-capping agent,
the aromatic diamine monomer comprises a 2,2′-bis(trifluoromethyl)benzidine, and based on a usage amount of 100 mol % of the aromatic diamine monomer, a usage amount of the 2,2′-bis(trifluoromethyl)benzidine is 70 mol % or more.

2. The poly(amide-imide) copolymer of claim 1, wherein the poly(amide-imide) copolymer comprises an amide structural unit and an imide structural unit, wherein the amide structural unit is formed by reacting the aromatic diamine monomer and the diacyl chloride monomer, and the imide structural unit is formed by reacting the aromatic diamine monomer and the tetracarboxylic dianhydride monomer.

3. The poly(amide-imide) copolymer of claim 1, wherein the aromatic diamine monomer further comprises at least one of 2,2′-bis(3-amino-4-hydroxyphenyl)hexafluoropropane, 4,4′-diaminodiphenylsulfone, and 3,3′-diaminodiphenylsulfone.

4. The poly(amide-imide) copolymer of claim 1, wherein a weight-average molecular weight thereof is between 150,000 and 500,000.

5. The poly(amide-imide) copolymer of claim 1, wherein the tetracarboxylic dianhydride monomer comprises at least one of 4,4′-(hexafluoroisopropylidene)diphthalic anhydride, 3,3′,4,4′-biphenyltetracarboxylic dianhydride, and 1,2,3,4-cyclobutanetetracarboxylic dianhydride.

6. The poly(amide-imide) copolymer of claim 1, wherein the silane compound having the alkoxy group comprises at least one of a silane compound having an alkoxy group and an amine group and a silane compound having an alkoxy group and an isocyanate group.

7. The poly(amide-imide) copolymer of claim 6, wherein the silane compound having the alkoxy group and the amine group comprises at least one of (3-aminopropyl)triethoxysilane and (3-aminopropyl)trimethoxysilane.

8. The poly(amide-imide) copolymer of claim 6, wherein the silane compound having the alkoxy group and the isocyanate group comprises 3-isocyanatopropyltriethoxysilane.

9. The poly(amide-imide) copolymer of claim 1, wherein the diacyl chloride monomer comprises at least one of terephthaloyl chloride, isophthaloyl dichloride, 4,4′-diphenoyl chloride, and 2,2′-diphenoyl chloride.

10. The poly(amide-imide) copolymer of claim 1, wherein based on a total usage amount of 100 parts by mole of the diacyl chloride monomer and the tetracarboxylic dianhydride monomer, a usage amount of the aromatic diamine monomer is between 70 parts by mole and 100 parts by mole, a usage amount of the diacyl chloride monomer is between 30 parts by mole and 70 parts by mole, a usage amount of the tetracarboxylic dianhydride monomer is between 30 parts by mole and 70 parts by mole, and a usage amount of the silane compound having the alkoxy group is between 5 parts by mole and 20 parts by mole.

11. A poly(amide-imide) copolymer comprising a structural unit represented by formula (1), a structural unit represented by formula (2), a structural unit represented by formula (3), and a silicon-oxygen-silicon bond, 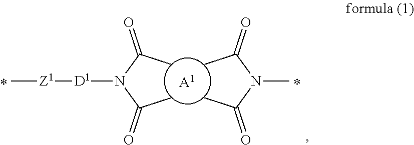
in formula (1), A¹ is a tetravalent organic group, D¹ is a divalent organic group, Z¹ is a single bond or —NH—, and * represents a bonding position, 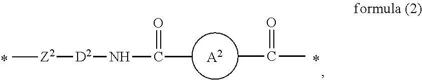
in formula (2), A² is a divalent organic group, D² is a divalent organic group, Z² is a single bond or —NH—, and * represents a bonding position,
in formula (1) and formula (2), at least one of D¹ and D² is a structure represented by formula (D-1), wherein based on a total amount of 100 mol % of D¹ and D² in the poly(amide-imide) copolymer, an amount of the structure represented by formula (D-1) is 70 mol % or more, 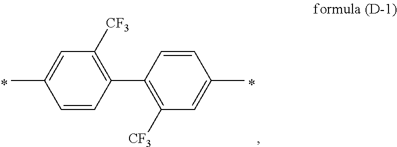
wherein * represents a bonding position, 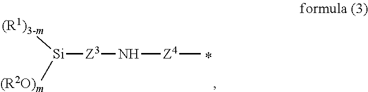
in formula (3), Z³ is an alkylene group, an alkenylene group, an alkynylene group, a cycloalkylene group, a cycloalkenylene group, or an arylene group, R¹ and R² are an alkyl group, an alkenyl group, an alkynyl group, a cycloalkyl group, or a phenyl group, respectively, m is an integer of 1 to 3, Z⁴ is a single bond or a structure represented by formula (3-a), and * represents a bonding position, 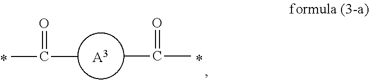
in formula (3-a), A³ is a divalent organic group, and * represents a bonding position.

12. The poly(amide-imide) copolymer of claim 11, wherein A¹ is 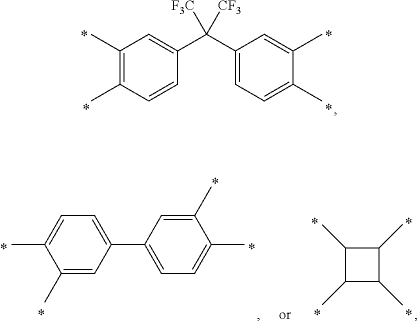
wherein * represents a bonding position.

13. The poly(amide-imide) copolymer of claim 11, wherein A² and A³ are respectively 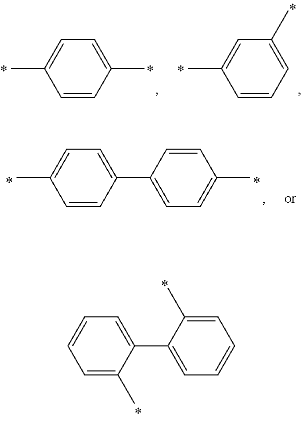
wherein * represents a bonding position.

14. The poly(amide-imide) copolymer of claim 11, wherein in formula (1) and formula (2), when D¹ and D² are not the structure represented by formula (D-1), D¹ and D² are respectively 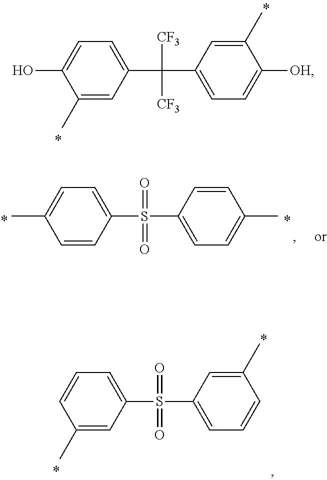
wherein * represents a bonding position.

15. A composition for a thin film, comprising the poly(amide-imide) copolymer of claim 1.

16. The composition for the thin film of claim 15, further comprising an end-capping isocyanate, wherein the end-capping isocyanate has a structure represented by formula (4), 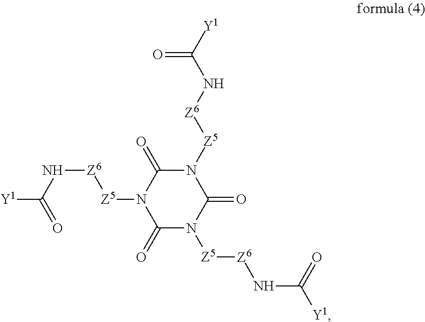
in formula (4), Z⁵ is a single bond or a carbonyl group, Z⁶ is a substituted or unsubstituted alkylene group or a substituted or unsubstituted cycloalkylene group, Y¹ is 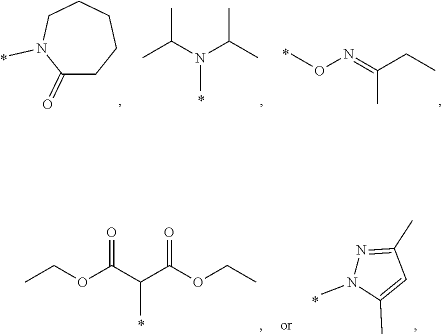
wherein * represents a bonding position.

17. A thin film formed by the poly(amide-imide) copolymer of claim 1.
